(19) United States
(12) Patent Application Publication
(10) Pub. No.: US 2021/0049831 A1
(43) Pub. Date: Feb. 18, 2021

(54) REAL-TIME RACING LAP TIME USER FEEDBACK & COMMUNICATION SYSTEM

(71) Applicant: MyPitboard Inc., Ottawa (CA)

(72) Inventors: Robert Edward POLLAK, III, Ottawa (CA); Nicholas FEKETE, Gatineau (CA); Tyler MEDAGLIA, Ottawa (CA); ZhenHao WU, Ottawa (CA)

(21) Appl. No.: 16/993,415

(22) Filed: Aug. 14, 2020

Related U.S. Application Data
(60) Provisional application No. 62/887,884, filed on Aug. 16, 2019.

(51) Int. Cl. G07C 1/24; A63B 71/06; B60K 35/00; H04W 4/80

(52) U.S. Cl. CPC G07C 1/24; A63B 71/0686; B60K 35/00; H04W 4/80; B60K 2370/816; B60K 2370/5911; B60K 2370/48; B60K 2370/77; B60K 2370/152

(57) ABSTRACT

An onboard real-time lap, segment, section and start (“holeshot”) time measuring and feedback system for racing is provided. The system further provides a communication link between a third party (mobile device, team/team members, other participants) and the racer. The system digitally recreates and enhances what is known as a “pit board” or manual written means of communicating with the user. Additional training features are optionally provided. Post-race/practice data may then be uploaded to a mobile device for further analytics and comparison amongst other racers, athletes and/or other users.

### CROSS-REFERENCE TO RELATED APPLICATION

This application claims the benefit of and priority to U.S. Patent Application No. 62/887,884, filed on Aug. 16, 2019, and entitled “REAL-TIME RACING LAP TIME USER FEEDBACK & COMMUNICATION SYSTEM,” which is hereby incorporated by reference as if fully set forth herein.

### FIELD OF THE INVENTION

This invention pertains to the field of racing and more particularly, to a real-time racing lap time user feedback and communication system.

### BACKGROUND

Racing has been around for millennia and like every sport, competition pushes athletes to train harder and smarter to find that edge to help them succeed over others. Consequently, sports evolve as next generation athletes push the boundaries. Technology now plays significant role in finding that edge. Real-time data displayed in an appropriate fashion is the best way for racers, and their team to optimize performance and modify strategies in response to success and failure. In sports where time is the final determiner of success, every fraction of a second counts. Advanced real-time feedback tools are now needed to help racers push towards their goal every time they are practicing or racing.

In most fields of racing there are little to limited tools that are commercially available for providing racers with real-time lap time feedback. Technologies that provide lap time feedback are not specifically tailored towards these racing environments and do not offer the accuracy needed for most racing applications such as; go-karting, motocross racing, downhill mountain biking, skiing and others.

Current communication technology consists of dedicating a specific area of the track to manually inform the racer of the relevant information. The display of information in this manner is often results in the relevant information not being readily accessible by the actual racer in real-time. In some sports, information is presented via small white board, (pit board) in which a crew member writes down relevant information with regards to the racer or athlete. This current methodology limits the crew member to one certain section of the race course in which their view is limited due to the confines of the dedicated area and may not be able to convey all of the information due poor visibility or obstructions.

The state-of-the-art technologies do not involve automated real-time feedback that is provided to the racers via an onboard communication link. Furthermore, these technologies do not offer a real-time data link from the racer, athlete and/or other users to teams/team members during its use. All known technologies available to the public are not specifically tailored towards such fields of racing and do not provide a communication link between the racer and crew member. Technologies that provide lap time data are in the form of a watch in which the screen size is very limited and hard to read. Other forms of lap-time feedback that exists involves the use of mounting a mobile phone which is highly undesirable due to the nature of the harsh environment of water, sand, dirt mud, snow and etc. All post track/race lap-time and data analytic products currently available on the market do not provide any real-time feedback and all data must be synched with a mobile communication device after the racer's session is complete.

This invention addresses the need of having an electronic on-board system to inform racers, athletes and/or other users of lap times as well as other relevant real-time information and/or other information provided by or to the assisting crew member/members at their choosing. This invention specifically digitally recreates and enhances the use of a modern “pit board” or manual written means of communicating with the user.

### SUMMARY OF THE INVENTION

An object of the present invention is to provide a real-time racing lap time user feedback and communication system. In accordance with an aspect of the invention, there is provided a real-time racing system comprising a vehicle mount and real-time feedback electronic device, the electronic device comprising a display screen or indicator, GPS and Bluetooth receiver, cellular communication module for real-time data transfer, energy storage system, and microprocessor comprising a memory having stored thereon real-time racing software, optionally the vehicle mount is configured for mounting on an off-road motorcycle and comprises a handle bar pad configured to receive the electronic device and a handle bar cover configured to secure the electronic device to the pad.

The presented invention is configured to provide an onboard real-time feedback system for racers and their team. Optionally, information provided to the racer includes one or more of lap, segment, section and start (“holeshot”) time. In some embodiments, this system further provides a communication link between a third party (mobile device, team/team members, other participants) and the racer. In such embodiments, the invention digitally recreates and enhances the “pit board”.

In some embodiments, additional training features are integrated within the software which allows for this invention to enhance the training of racers through a virtual racing environment. The electronics measure, assess, communicate and display relevant data are embedded within a mounting system that is designed for the sport of interest. Post-race/practice data may then be uploaded to a computing device for further analytics and comparison amongst other racers or past performance. Accordingly, in some embodiments, post-race analysis software optionally in the form of an application is provided.

In some embodiments, real-time racing information that is conveyed to the racer includes but is not limited to one or more of lap, segment, section, split and start times as well as heart rate and brief messages from the crew to the user. In some embodiments, the system is configurable to include information the racer wishes to see and optionally in a preferred format. Optionally, the system is configurable to rely real-time data through the device to third parties, for example, the team for further analytics while the racer is on the track. Furthermore, data may be uploaded to a mobile or desktop device post track where the racer can then analyze the information in depth after the fact.

In some embodiments, the device is configured to provide a real-time data link that allows for two-way data exchange between a racer and crew or any other personnel deemed relevant. Optionally, a virtual race feature is provided in which lap-times are compared with an existing users specific track data or with a user determined set time to provide a real-time virtual race to enhance simulation and training of racing scenarios while practicing.

The racing apparatus comprises a display screen and/or indicator, GPS and Bluetooth receiver, cellular communication module for real-time data transfer, energy storage system, and microcontroller/microprocessor along with all other associated mechanical and electrical hardware to provide necessary functionality.

The invention is configurable for use in all fields of racing or others in which real-time feedback systems may be integrated with equipment of the sport. The invention is used as a real-time feedback and performance optimization tool for racers and/or a communication link between crew and athlete during competition. Optionally, the invention is configurable to relay any real-time data to teams/team members or others during its use.

### BRIEF DESCRIPTION OF THE DRAWINGS

Some embodiments of the present invention are illustrated as an example and are not limited by the Figures of the accompanying drawings, in which like references may indicate similar elements and in which:

FIG. 1 exhibits the present invention, the real-time racing apparatus, mounted on an off-road motorcycle.

FIG. 2 demonstrates multiple viewpoints of the real-time racing apparatus mounted on a motorcycle steering head and handle bar clamps.

FIG. 3 is an isometric view of the complete real-time racing apparatus and all of its composed embodiments.

FIG. 4 illustrates a top and bottom view of the complete real-time racing apparatus and all of its composed embodiments.

FIG. 5 depicts an isometric exploded view of the real-time racing apparatus and all of its composed embodiments.

FIG. 6 illustrates an isometric view of a mobile device that is hosting the real-time racing feedback software.

FIG. 7 exhibit a top and bottom view of the flat cell battery real-time racing apparatus feedback device.

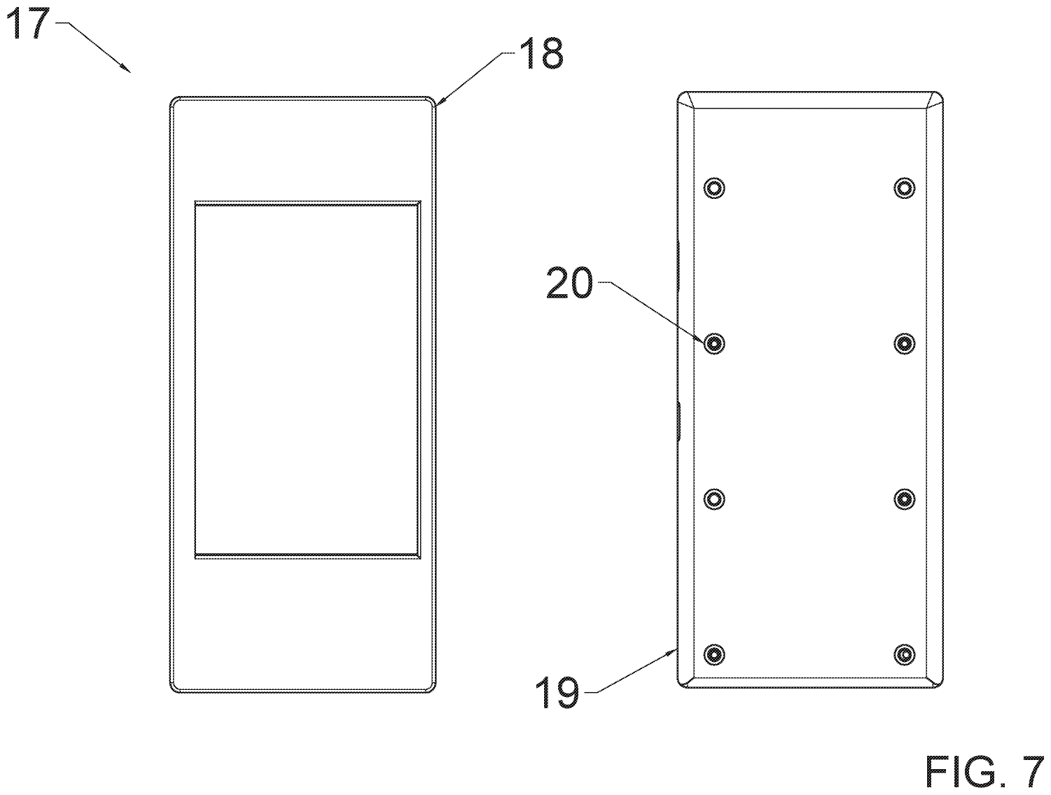

FIG. 8 details a front, back, left and right view of the flat cell battery real-time racing apparatus feedback device.

FIG. 9 illustrates an isometric view of a cylindrical cell battery real-time feedback electronic device.

FIG. 10 demonstrates a top and bottom view of the cylindrical cell battery real-time feedback electronic device.

FIG. 11 is a front, back, left and right view of the cylindrical cell battery real-time feedback electronic device.

FIG. 12 details an exploded view of the cylindrical cell battery real-time feedback electronic device and all of its composed embodiments.

FIG. 13 depicts an isometric view of the top of the real-time feedback electronics enclosure.

FIG. 14 is a top and bottom view of the top of the real-time feedback electronics enclosure.

FIG. 15 shows a front, back, left and right view of the top of the real-time feedback electronics enclosure.

FIG. 16 illustrates an isometric view of the bottom of the real-time feedback electronics enclosure.

FIG. 17 depicts a top and bottom view of the bottom of the real-time feedback electronics enclosure.

FIG. 18 demonstrates a front, back, left and right of the bottom of the real-time feedback electronics enclosure.

FIG. 19 is an isometric view of the real-time racing apparatus handle bar pad.

FIG. 20 illustrates a top and bottom view of the real-time racing apparatus handle bar pad.

FIG. 21 details the symmetrical side and front view of the real-time racing apparatus handle bar pad.

FIG. 22 demonstrates an isometric view of a real-time racing apparatus handle bar pad design variant.

FIG. 23 illustrates a top, bottom, left, right and front of the real-time racing apparatus handle bar pad design variant.

FIG. 24 provides a top view of the real-time racing apparatus handle bar pad cover.

FIG. 25 illustrates a bottom view of the real-time racing apparatus handle bar pad cover.

FIG. 26 is a top view of the real-time racing apparatus handle bar pad anti-glare cover.

FIG. 27 depicts a bottom view of the real-time racing apparatus handle bar pad anti-glare cover.

FIG. 28 demonstrates the real-time racing apparatus process operational flow chart.

### DETAILED DESCRIPTION OF THE INVENTION

The terminology used herein is for the purpose of describing the particular embodiments only and is not intended to be limiting of the invention. As used herein, the term “and/or” includes any and all combinations of one or more of the associated listed items. As used herein, the singular forms “a”, “an” and “the” are intended to include the plural forms as well as the singular forms, unless the context clearly indicates otherwise. It will be further understood that the terms “comprises” and/or “compromising”, when used in this specification, specify the presence of stated features, steps, operations, elements, and/or components, but do not preclude the presence or addition of one or more other features, steps, operations, elements, components, and/or groups thereof.

Unless otherwise defined, all terms including technical terms used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

A new real-time racing apparatus for the use as a real-time information feedback tool as well as a two-way data link between racer and crew are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures and description presented herein.

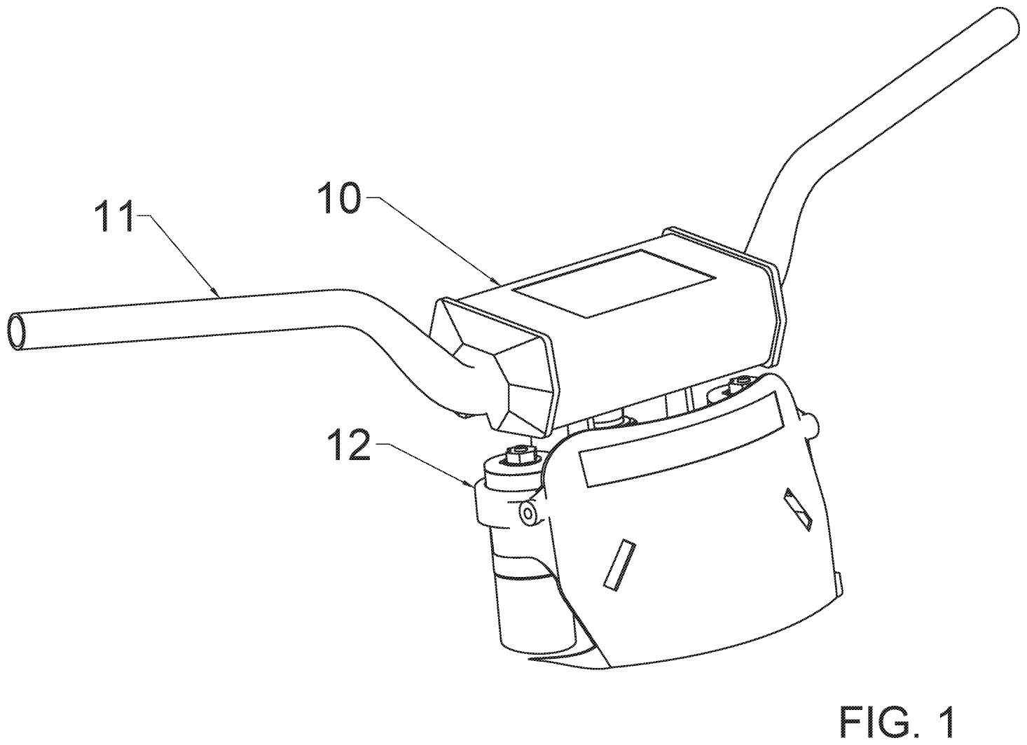

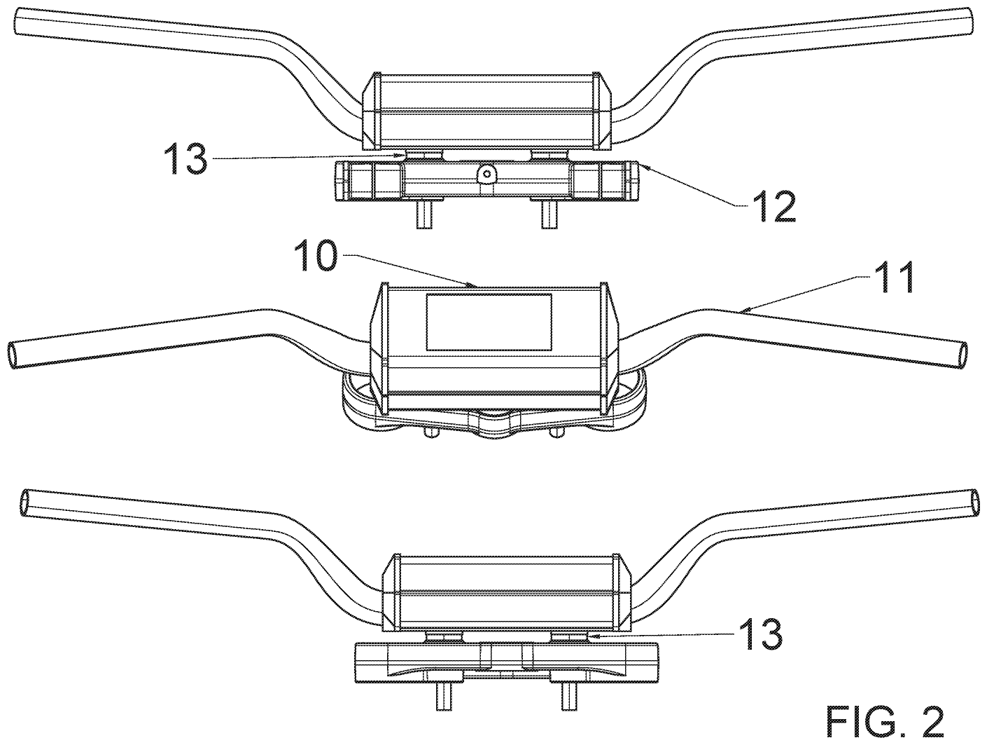

The present invention will now be described by referencing the appended sheets representing preferred embodiments. FIG. 1 depicts the real-time racing apparatus, 10, mounted on an off-road motorcycle. The real-time racing apparatus, 10, is mounted to the motorcycle steering head, 12, via the handle bar mount, 13, as demonstrated in FIG. 2. The real-time racing apparatus' handle bar pad, 14, is press-fit onto the handle bar mounts, 13, and handle bars, 11. The real-time racing apparatus with all of its embodied components embedded within the handle bar pad is then further secured to the steering head, 12, via a handle bar pad cover, 15. The mounting and securing system, 14, 15 can be modified to fit any surface for any racing application in which the real-time feedback can be displayed to the racer via the onboard real-time feedback electronic device, 17. The mounting and securing system, 14, 15 is not limited to the bar pad and bar cover and may be mounted and secured to the racing vehicle in various other ways. The mounting and securing system, 14, 15 are to house and/or fasten the real-time feedback electronic device, 17, with its various embodiments to the vehicle.

The real-time feedback electronic device, 17, relays and displays all the relevant data through a display screen or indicator, 16, such as but not limited to lap-times, heart-rate, lap-segment difference, lap-time difference, elapsed time, temperature, text messages and virtual race split time differences. Furthermore, color differentiating ways are used on such information displayed through an indicator or text via a display for the racer to recognize key performance metrics quickly and effectively. An example of such would demonstrate lap-time text in green or red if the user current lap was faster or slower than the preceding lap respectively. The real-time feedback electronic device, 17, can be a mobile phone and/or any other specific real-time electronic feedback device with the features stated above but limited to. We present the disclosed invention herein with a specific electronic real-time feedback device that is specific but not limited to the motorcycle real-time racing apparatus, 10.

FIG. 2 illustrates three different viewpoints of the real-time racing apparatus, 10, mounted on a motorcycle steering head, 12. The top view is a front facing view of the real-time racing apparatus mounted onto a motorcycle steering head. The middle view provides a user's/rider's perspective of the real-time racing apparatus mounted on the motorcycle steering head. The bottom view is a rear facing perspective of the real-time racing apparatus, 10, mounted on a motorcycle steering head.

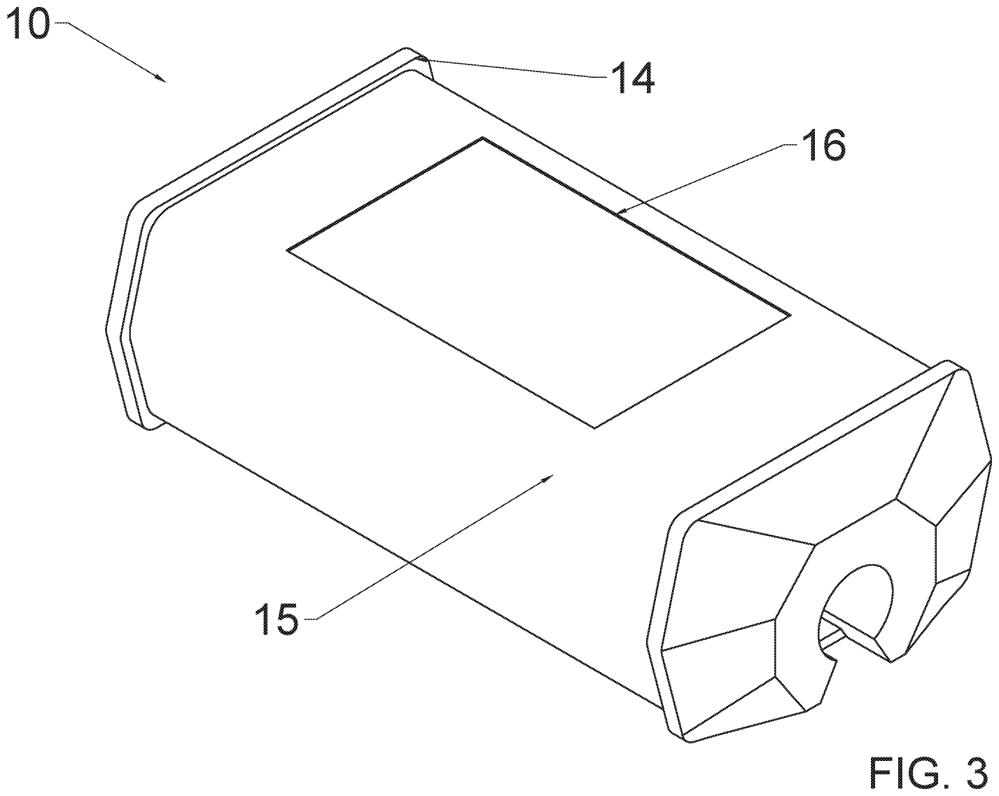

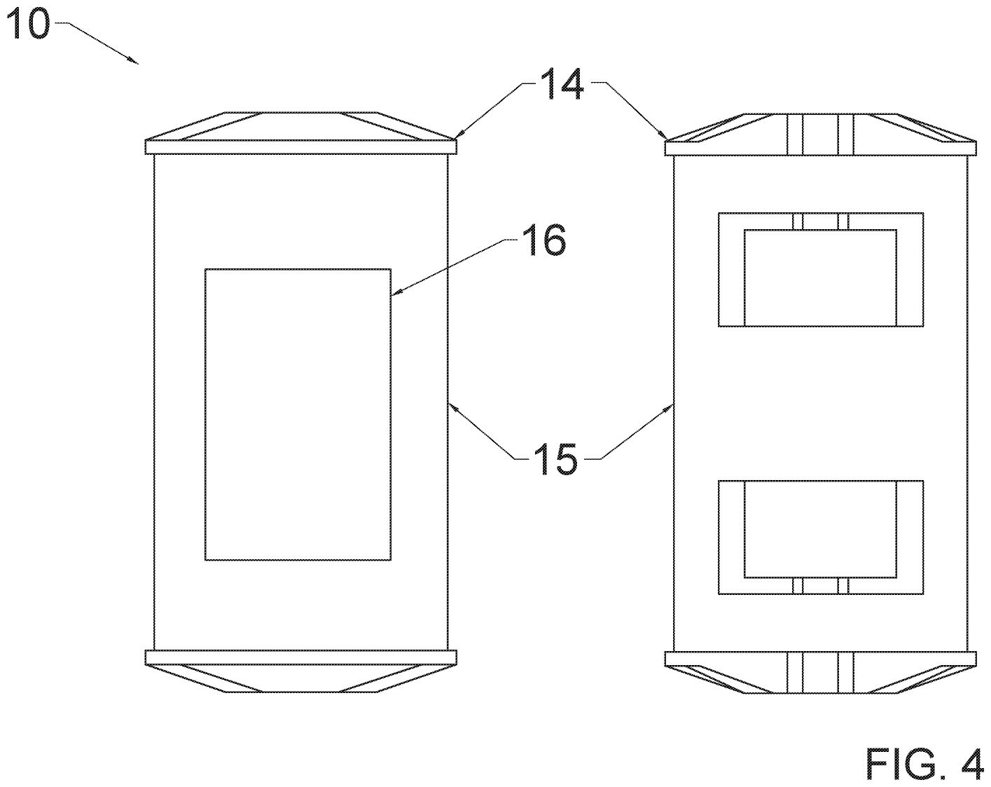

Demonstrated in FIG. 3 is an isometric view of the real-time racing apparatus unmounted from the motorcycle handlebars, handle bar mounts and steering head, 11, 12 and 13 respectively. The real-time racing apparatus, 10, comprises of but is not limited to three main components. First, the handle bar pad, 14, which fastens and houses the real-time feedback electronic device to the motorcycle and/or vehicle. Second, the handle bar pad cover, 15, which fastens and/or secures the real-time feedback electronic device to the handle bar pad, 14, and then further secures the handle bar pad and real-time feedback electronic device to the motorcycle and/or vehicle as demonstrated in FIGS. 1 and 2. Third, the real-time feedback electronic indicator, 16, such as but not limited to an electronic display and/or light emitting diodes (LED's) of various color ways. Furthermore, FIG. 4 demonstrates a top and bottom view of the real-time racing apparatus. The bottom view on the right of FIG. 4 demonstrates slots left open in order for the handle bar pad cover to secure the handle bar pad with the embodied real-time feedback electronic device to the handle bars and motorcycle handle bar mounts, 11 and 13 respectively.

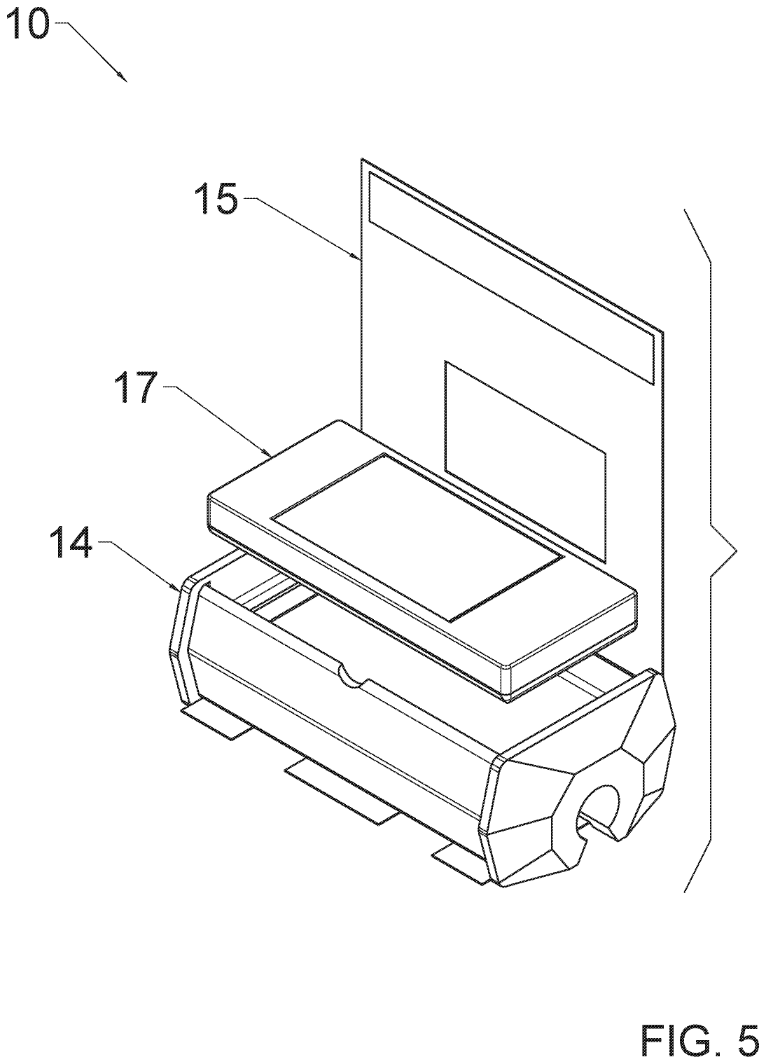

Illustrated in FIG. 5 is an exploded view of the real-time racing apparatus, 10, which demonstrates the various embodiments that the apparatus is composed of. The real-time feedback mounting system, 14, used for motorcycles is deemed a handle bar pad mounting device herein. The handle bar pad mounting device, 14, is a foam, but not limited to, handle bar pad which is a universal press fit, but not limited to, design to create a rigid fit over motorcycle handle bar and handle bar mounts, 11 and 13 respectively. The real-time feedback electronic device, 17, is then fit within the mounting device, 14, that is then further secured to the motorcycle handle bar mounts, 13 and hence steering head, 12 via the removable handle bar pad cover, 15. This removable handle bar pad cover, 15, fastens to itself around the motorcycle handle bar and handle bar mounts, 11 and 13, and handle bar pad mounting device, 14. The self-fastening handle bar pad cover, 15 and press fit handle bar pad mounting device, 14, secures the real-time racing apparatus, 10, to the motorcycle along with the various embodied components.

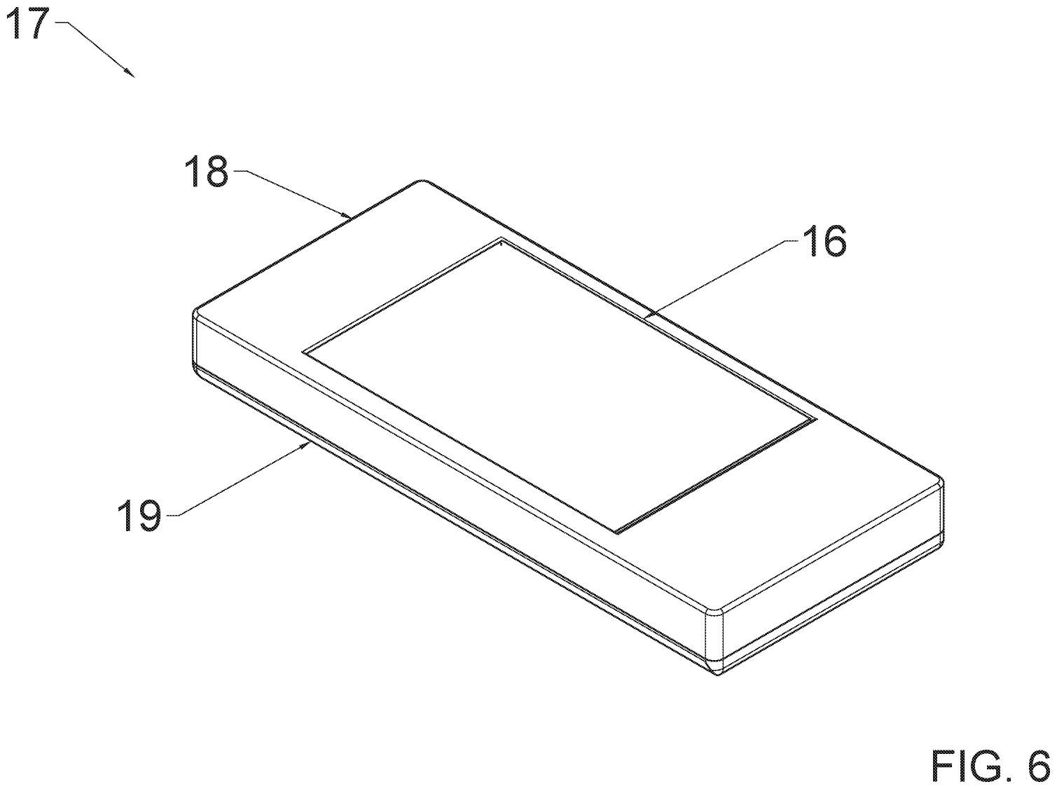

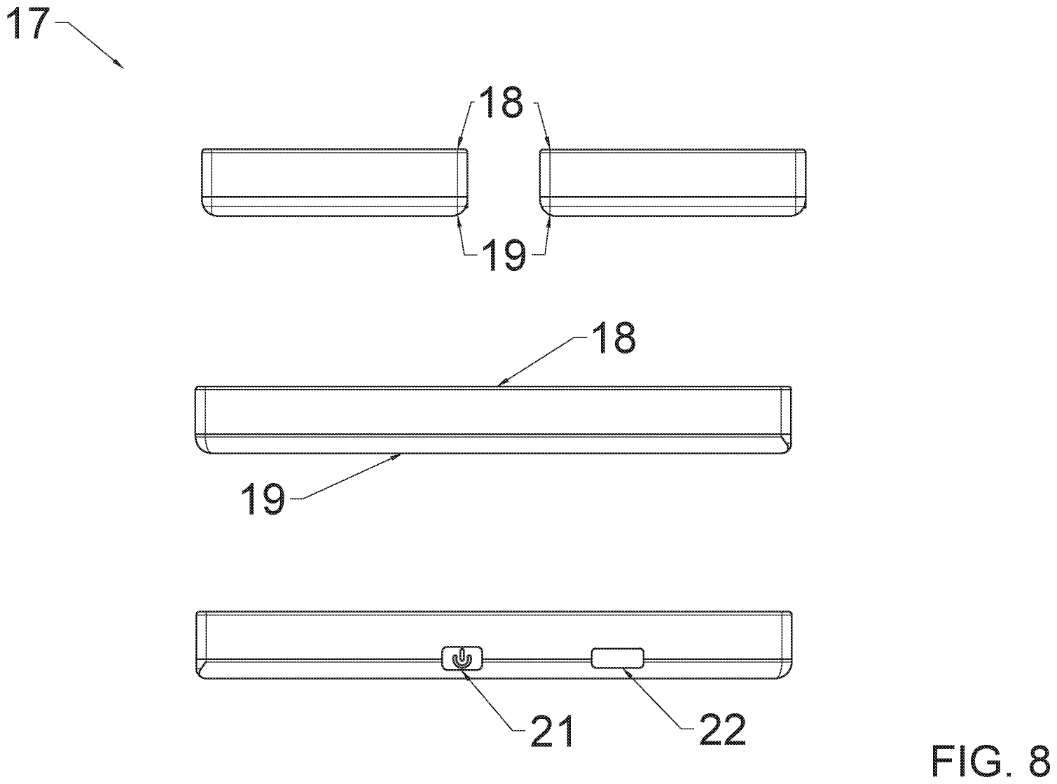

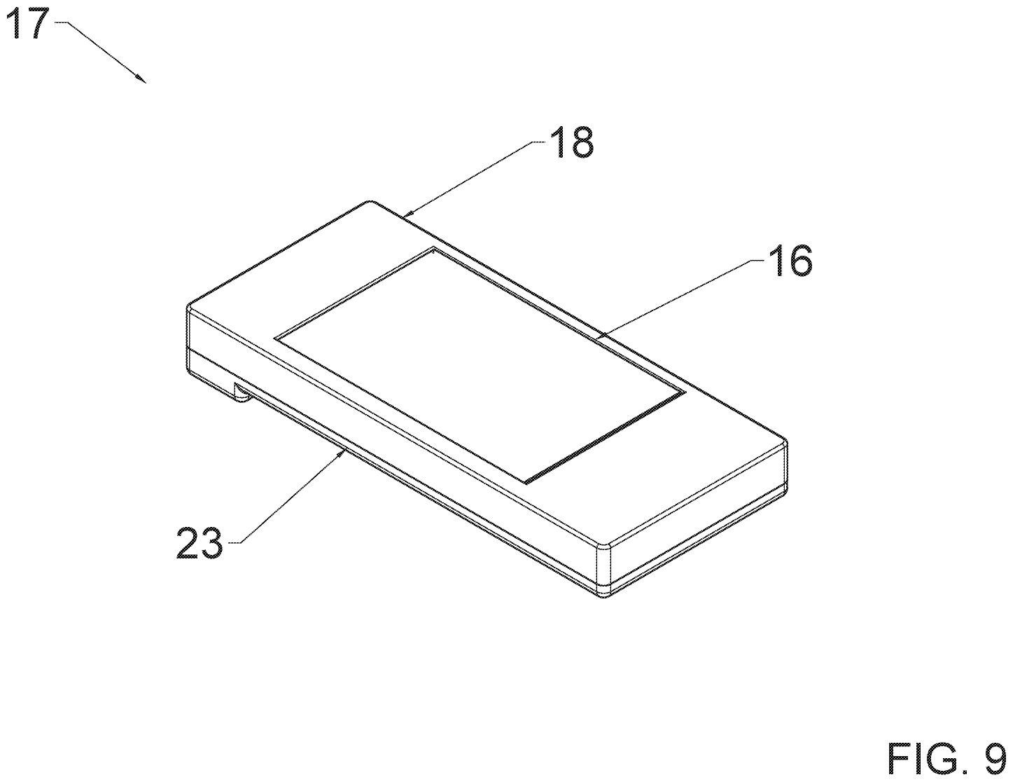

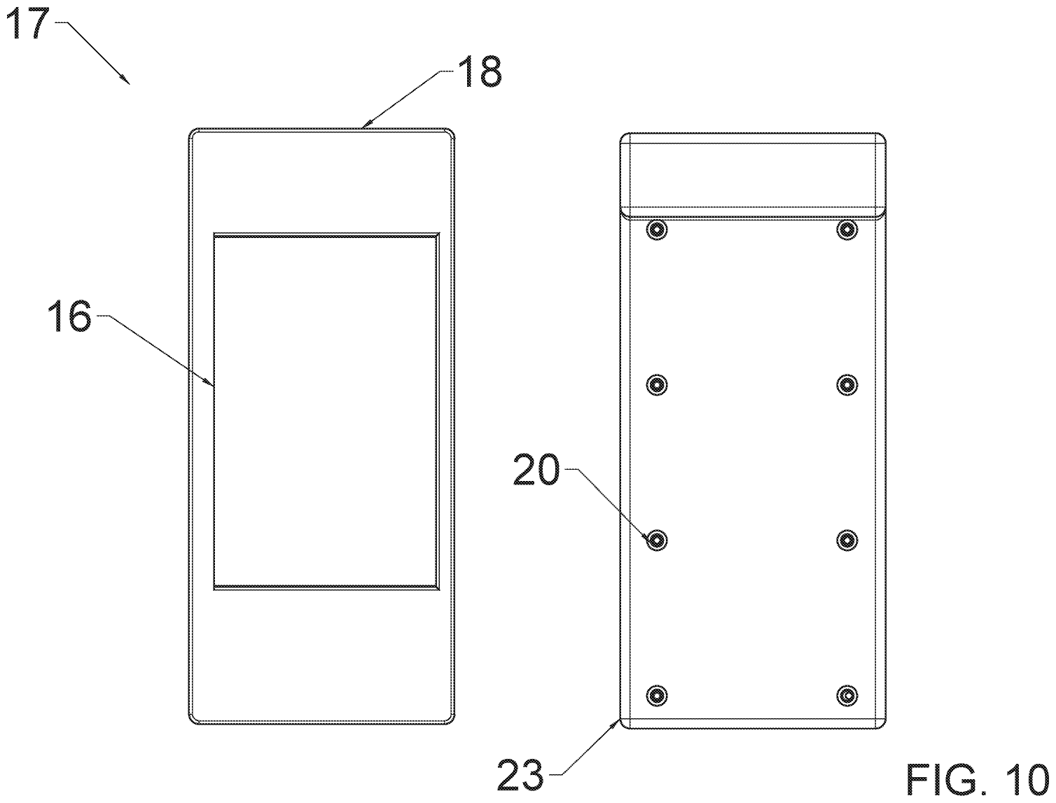

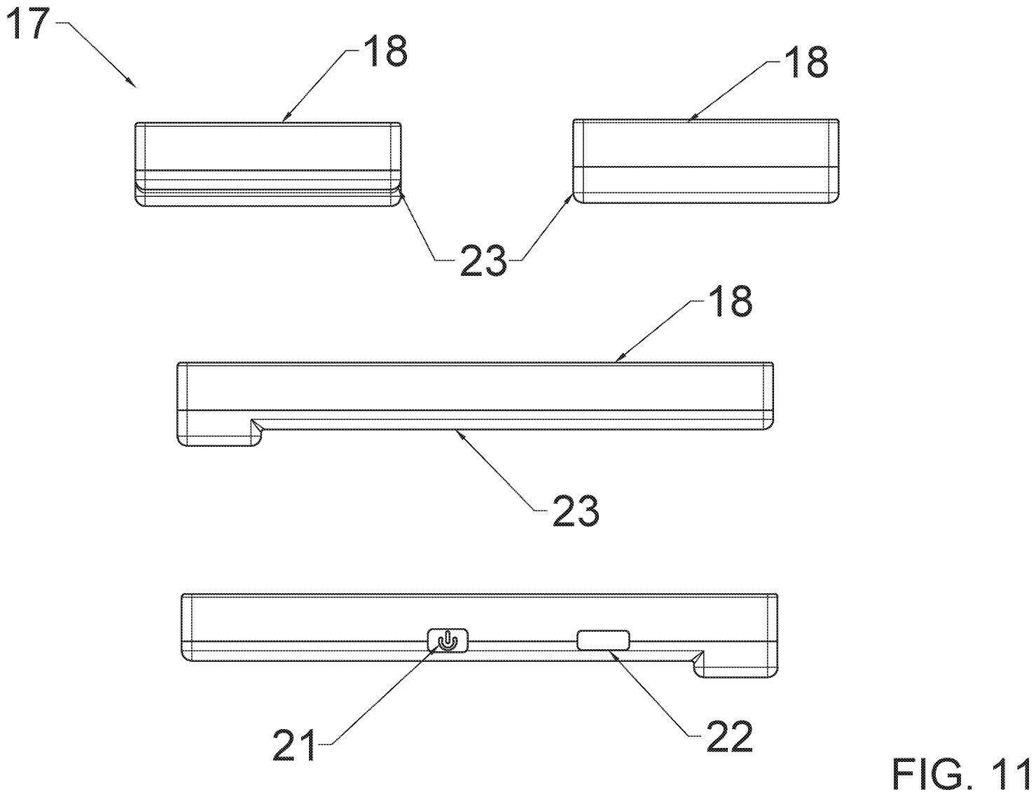

Depicted in FIG. 6 and FIG. 9 are isometric views of the real-time feedback electronic device, 17. This device is composed of a top enclosure, 18, and a bottom enclosure, 19 and 23. Located within the top of the enclosure, 18, is the real-time feedback indicator, 16. FIG. 8 and FIG. 10 demonstrate a top and bottom view of the electronics enclosure, 17, for their respective enclosure variations of flat and cylindrical cell batteries, but not limited to. The top enclosure, 18, and bottom enclosure, 19 and 23, which make up the real-time feedback electronic device, 17, are fastened together via fastening screws denoted by 20. FIG. 9 and FIG. 11 illustrate front, back, left and right views of the real-time feedback electronic enclosure, 17. The real-time feedback electronics enclosure, 17, is composed of either a polyethylene, polypropylene, Polylactic Acid (PLA), acrylonitrile butadiene styrene (ABS), Polyethylene Terephthalate Glycol-modified (PETG) plastic material and/or any other suitable material to provide a robust, rigid, water resistant and or waterproof enclosure for all mentioned but not limited to the embodied electronics components. On the right side of the real-time feedback electronic enclosure, 17, are the electronic power button cover, 21 and charging cable covers, 22. The electronic power button cover, 21 and charging cable cover, 22 are generally a silicon rubber material and/or any other suitable material to provide a robust, rigid, water resistant and/or waterproof power button cover and charging cable cover. The charging cable cover, 22, must be removable from the enclosure charging port.

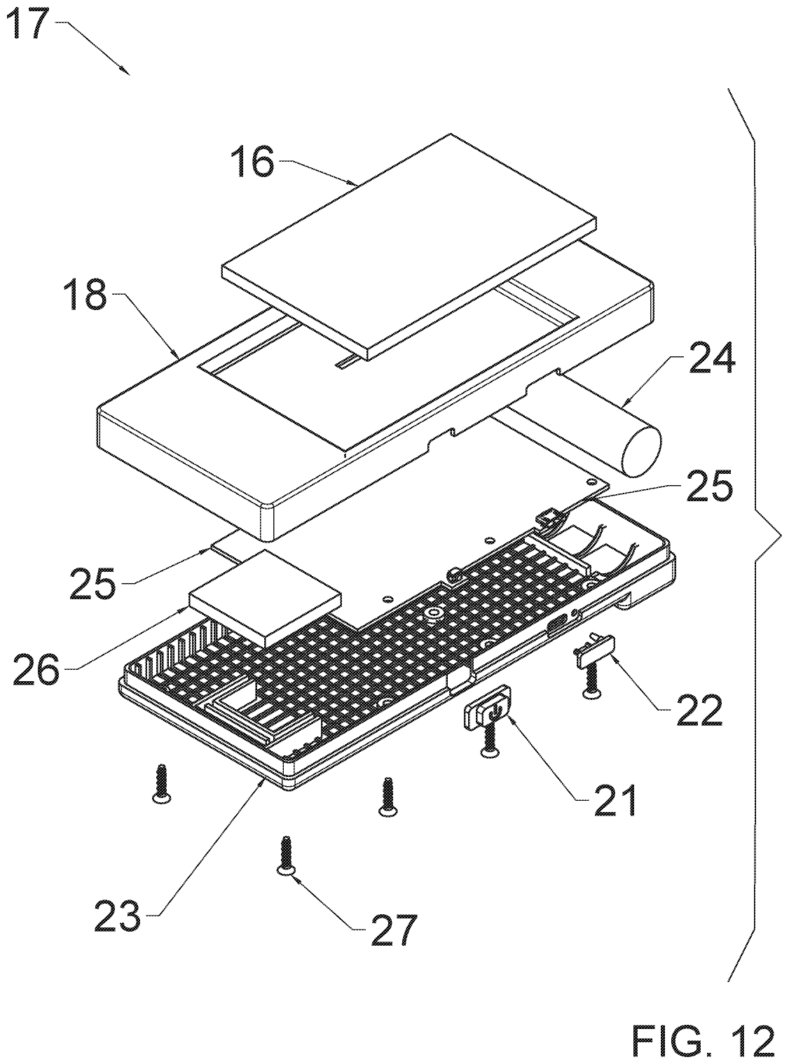

FIG. 12 demonstrates an isometric view of the exploded real-time electronics device, 17, which houses and secures all the various electronics components such as but not limited to the following: display screen and/or display indicators 16, printed circuit board assembly (PCBA) 25, battery and battery module 24, global navigation satellite system receiver (GNSS) receiver and/or global system for mobile communications (GSM) module 26 and/or Bluetooth and/or Bluetooth low energy (BLE) module 26. The real-time electronics enclosure, 18, 19 and 23, is to mount all required communications antennas clear of any object that has the capability of interfering with the electromagnetic line of sight such as but not limited to the display system and battery module.

The display screen 16 is composed of either a liquid crystal display (LCD) module, light-emitting diode (LED) display and/or any other suitable electronic display and/or indicator that can provide appropriate visual feedback to the racer. The display unit is to be secured to the top of the real-time racing apparatus electronics enclosure, 18, via a two-way fastening tape and/or any other suitable and robust means of mating the two different components together.

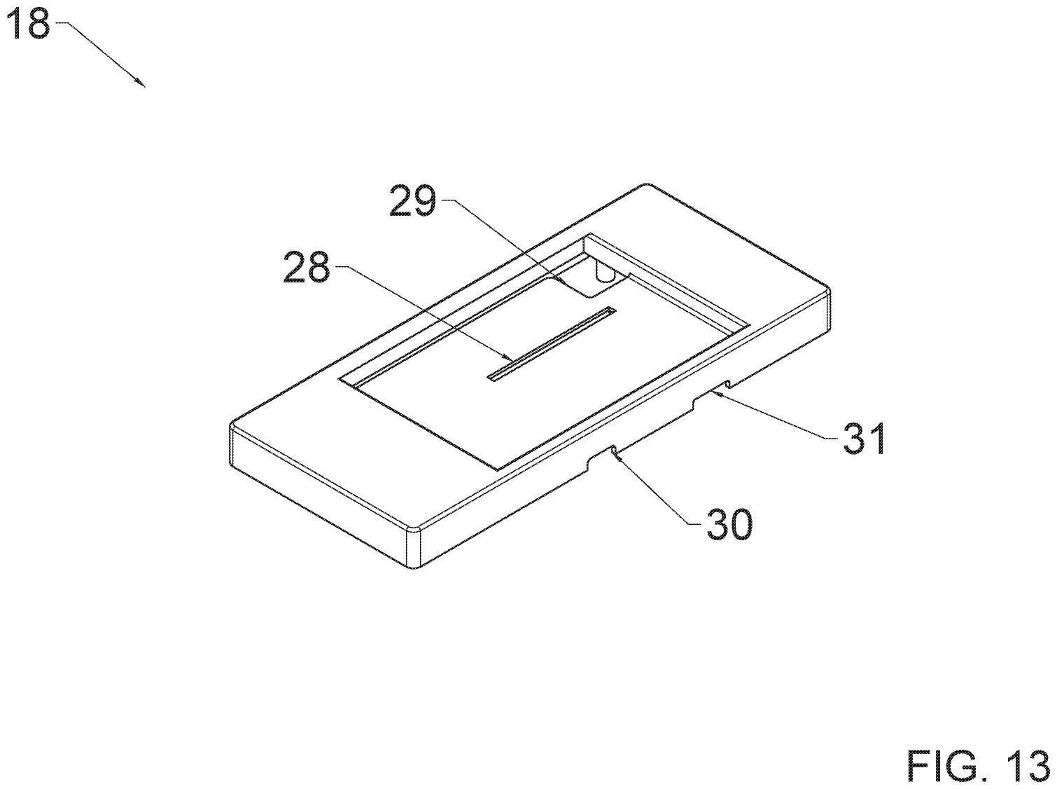

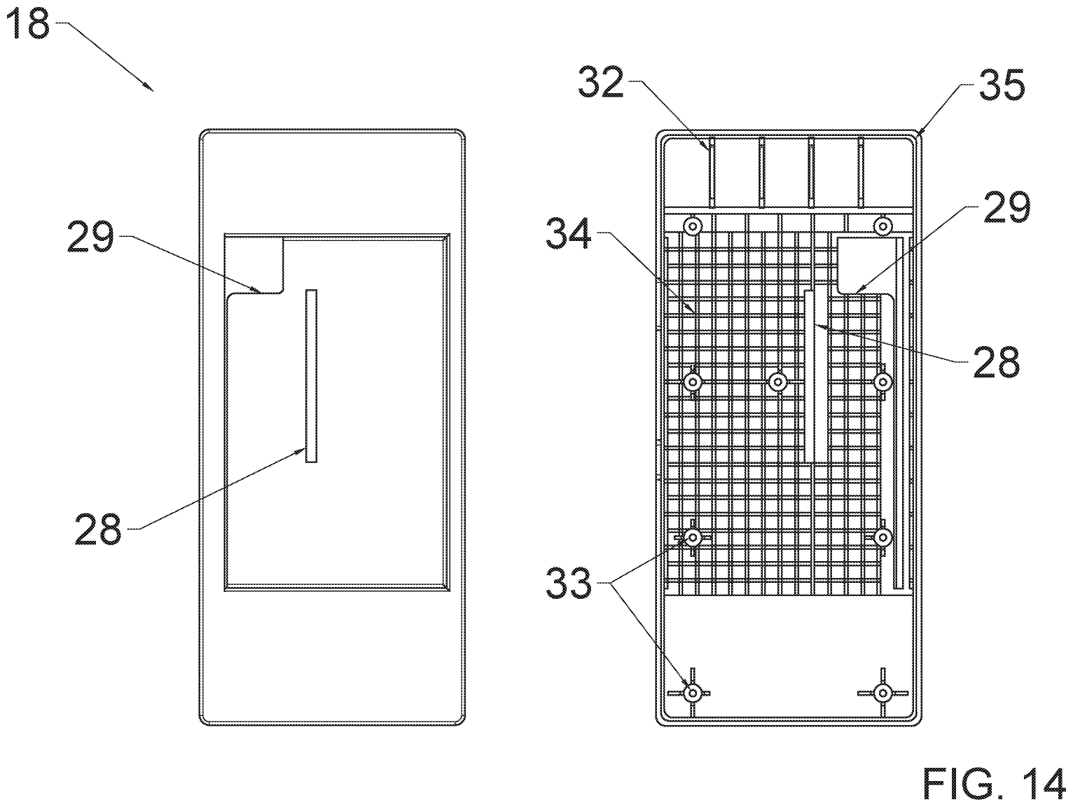

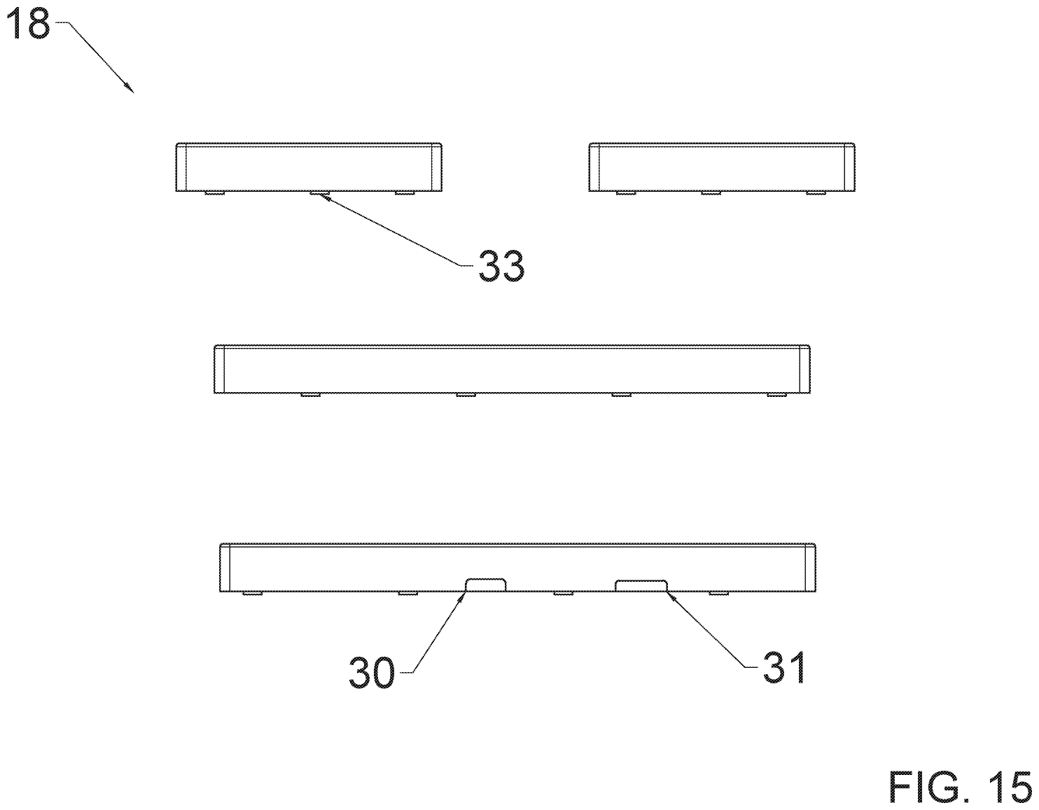

Depicted in FIG. 13 is a detailed isometric view of the top of the real-time feedback electronic enclosure, 18, denoted as the electronic enclosure top herein. The top of the electronics enclosure contains two rectangular openings, 28 and 29, which allow for the routing of cabling such as but not limited a flexible printed circuitry cable (FPC) for the display screen and/or indicator, 16. The display indicator, 16, is secured and/or fastened to the electronics enclosure top, 18, via a two way fastening tape. Furthermore, 16, contains two further slots 30 and 31 which allow the power button cover, 21, and the charging cable cover, 22, to be confined to the top and bottom of the electronics enclosure, 18, 19 and 21 respectively. FIG. 14 demonstrates a top and bottom view of the top of the electronics enclosure, 18. The battery is secured within the top and bottom of the enclosure via the cylindrical supports, 32. In order to increase the rigidity of the electronics enclosure, further supports are built into the top of the electronics enclosure, 18, as indicated by 34. The top and bottom of the electronics enclosure are aligned and secured together via a lip seal as indicated by 35. FIG. 15 provides the front, back, left and right view of the aforementioned top electronics enclosure and all of its associated details.

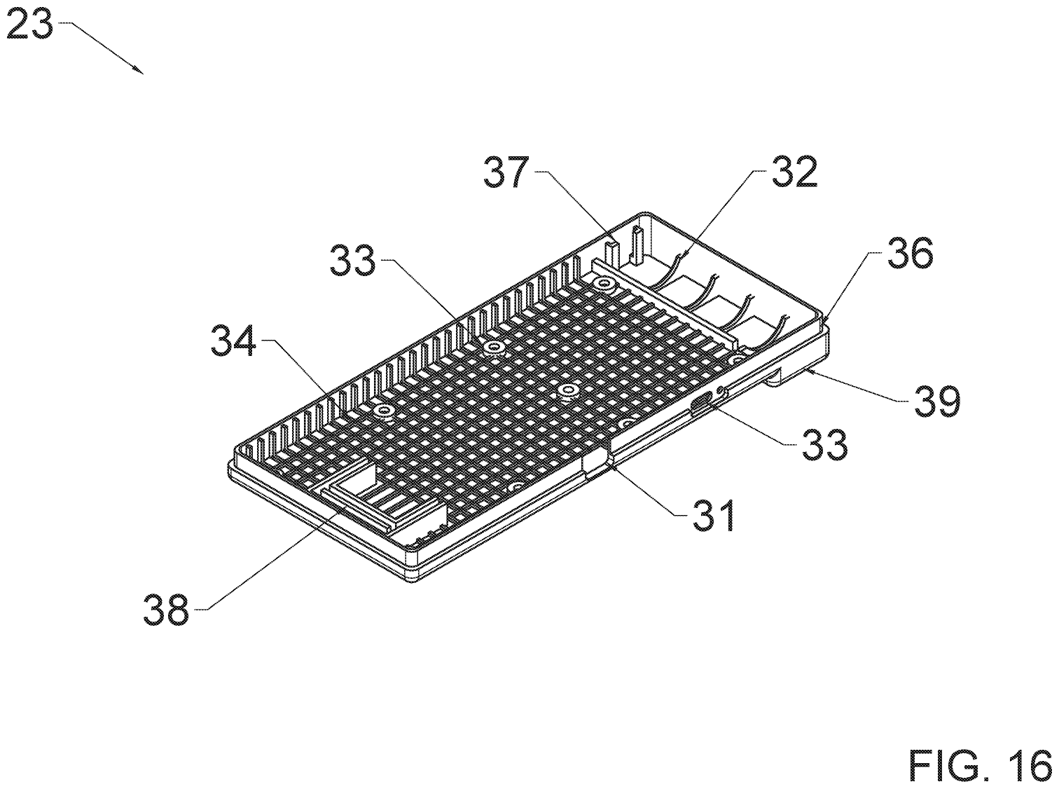

Shown in FIG. 16 is an isometric view of the real-time feedback electronic bottom enclosure, 23, denoted as the electronic enclosure bottom herein. Similar to the top of the electronic enclosure are the cylindrical supports, 32 that provide a rigid support for the cylindrical battery and further fasten and secure the battery to the enclosure. This battery securing system, 32, can be extended to a flat cell battery but not limited to the aforementioned battery shapes. The cylindrical battery is further secured to the bottom electronic enclosure via a spring-based battery holder located in 37. Indicated by 33 are fastener bosses and fastener holes, 20, that allow the fastening screws and/or any other proper means of a fastening mechanism to mate, fasten and secure the top and bottom electronic enclosure. Furthermore, communications antenna and/or communications PCBA, 26, is placed at the highest point within the enclosure via antenna/PCBA riser 38. The communication antenna and/or communications PCBA is fastened and secured to 38 via a two-way fastening tape, but not limited to.

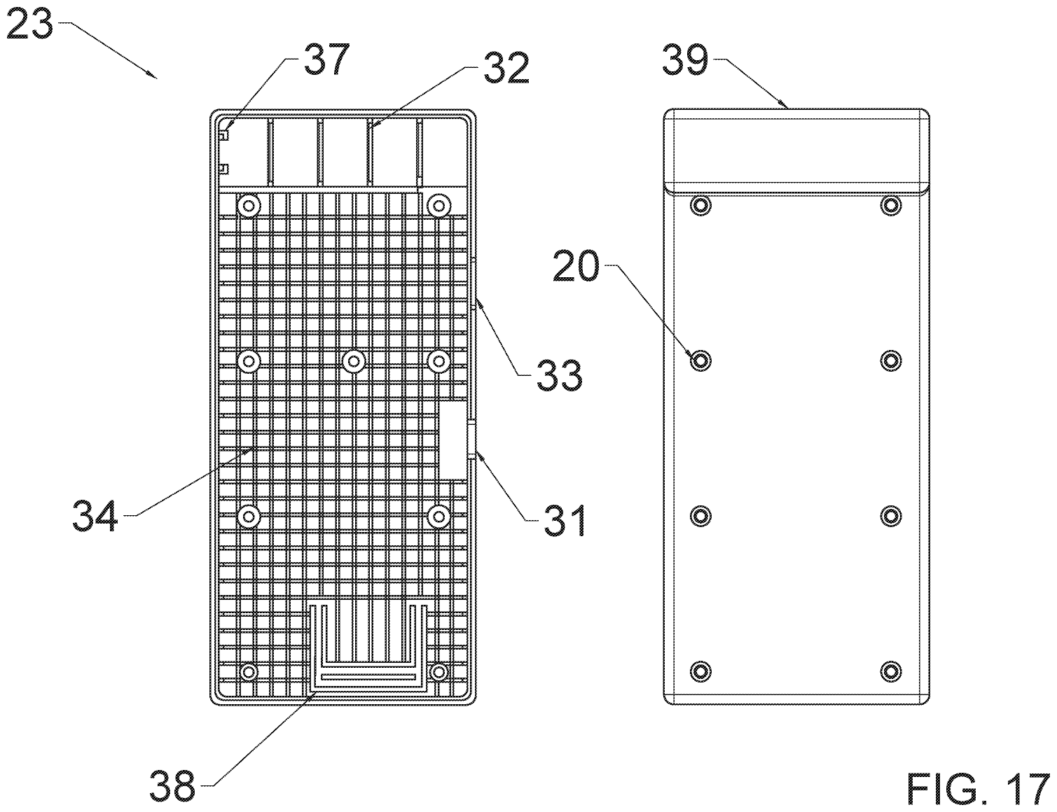

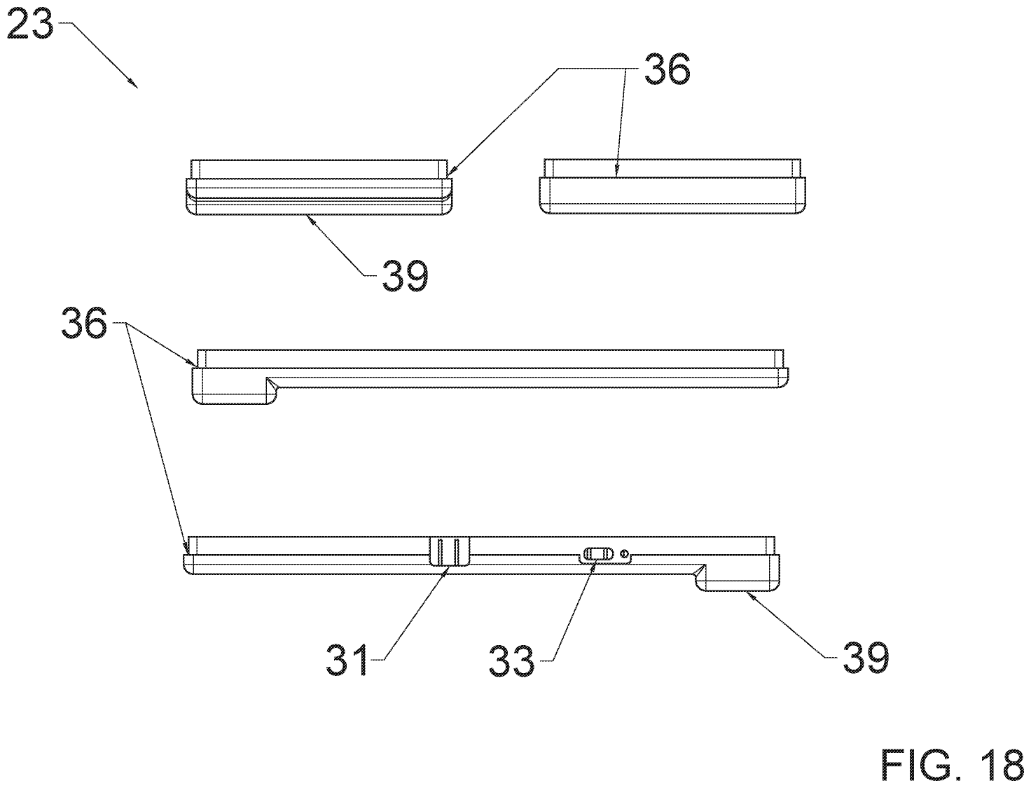

Similar to the top electronics enclosure, 18, the bottom electronic enclosure is reinforced via a vertical and horizontal grid support structure, 34. The combination of the bottom and top grid like support structure enhances the rigidity of the enclosure and therefore the real-time feedback electronic device. Analogous to the top electronics enclosure, the bottom electronics enclosure contains a female lip seal, 36, to further align, fasten and seal the top and bottom electronics enclosure. Moreover, the bottom enclosure contains a power button slot, 31, which provide a means for seating and securing the power button cover, 21, to the bottom electronic enclosure. Slot 33 provides an accessible opening for access to the charging port located on the main PCBA, 25, which can then further be covered with the charging cable cover, 22. Akin to the top electronics enclosure, FIG. 17 provides a top and bottom view of the bottom electronics enclosure whereas FIG. 18 provides a front, back, left and right view of the bottom of the electronics enclosure.

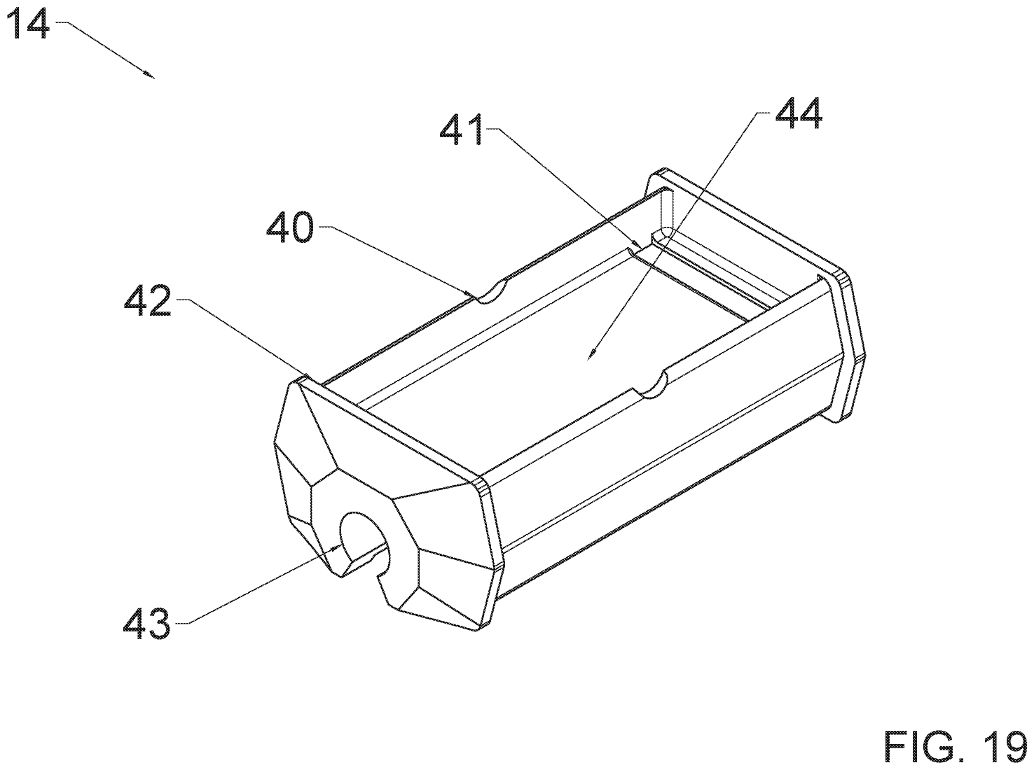

FIG. 19 provides an isometric view of the real-time racing apparatus handle bar pad, 14, which will be referred to as the handle bar pad herein. The handle bar pad serves as but is not limited to being a mounting and fastening mechanism which mounts the real-time feedback electronic device and/or mobile device, 17, to the motorcycle handle bar and handle bar mounts. The handle bar pad, 14, is primarily composed of a low to high density rigid closed cell or open cell Urethane, Neoprene foam. The handle bar pad foam, 14, may also be composed of many different durable materials such as Polyurethane, Polyethylene foam and/or any other similar or suitable materials which are capable of producing a suitable rigid mount to enclose the incorporated embodiment, 17. The handle bar pad, 14, provides a layer of protection between the handle bar mounts located on the motorcycle, the device and the user. Slots, 40, provide an area allowing for the user to easily access and remove the real-time feedback electronic device and/or mobile device, 17. An example of 40 is the user using their fingers to remove the real-time electronics device to charge their device.

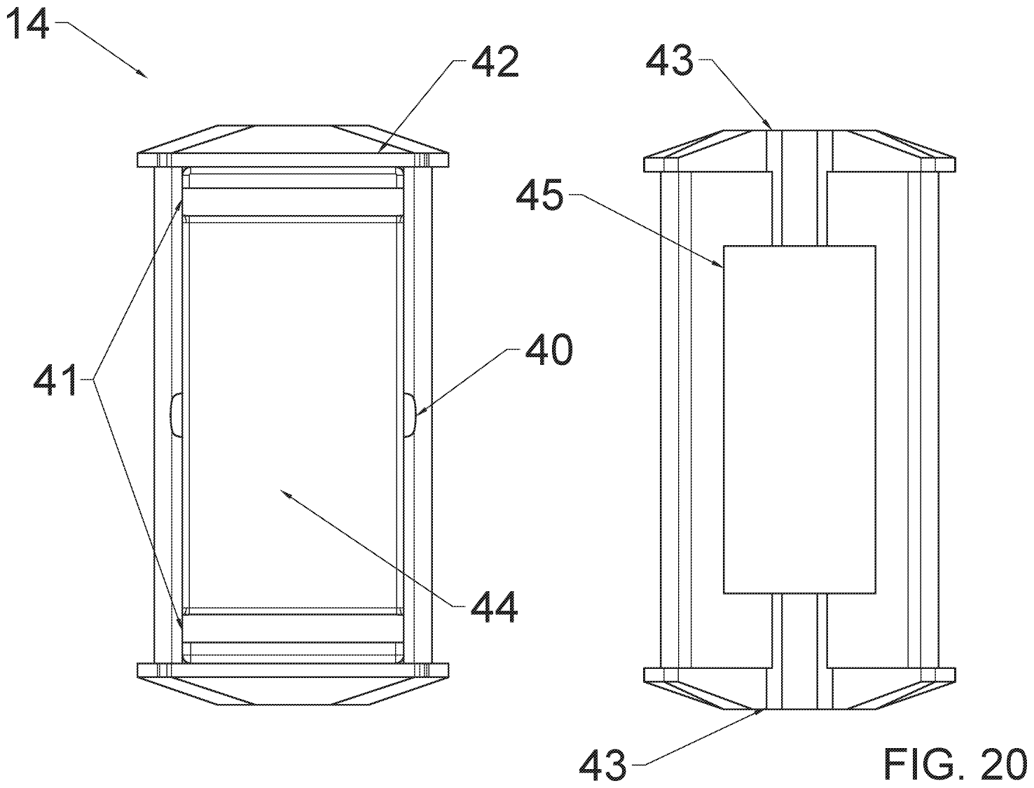

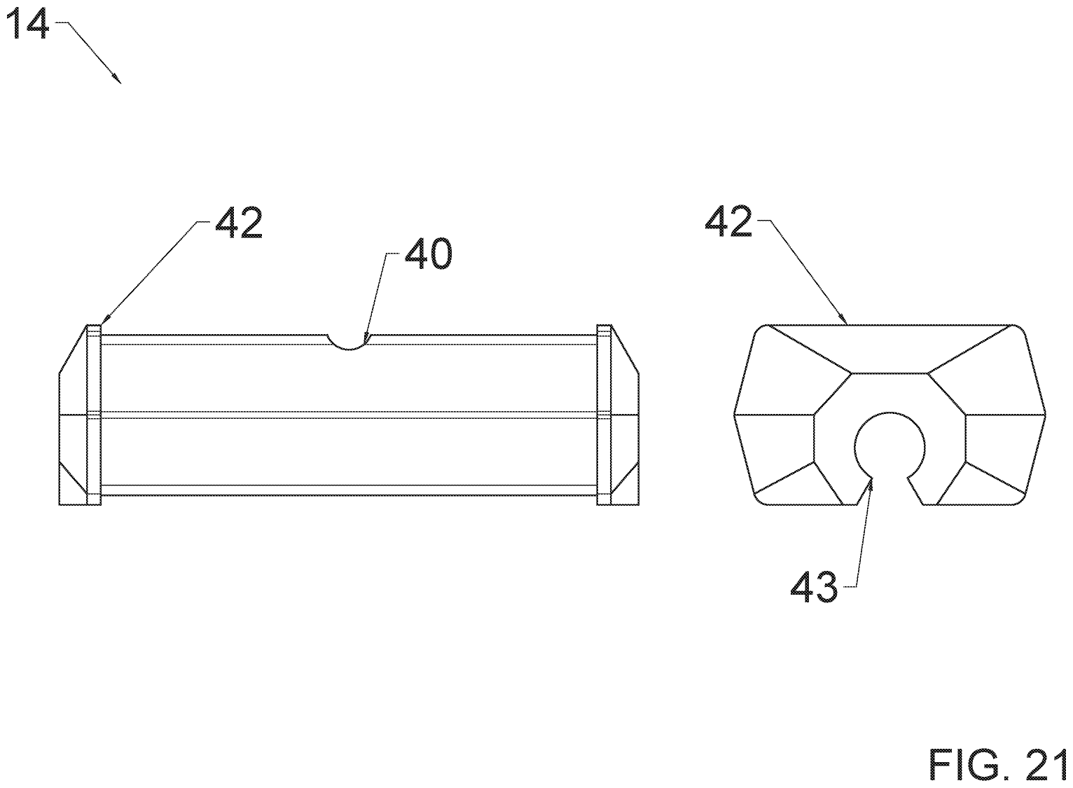

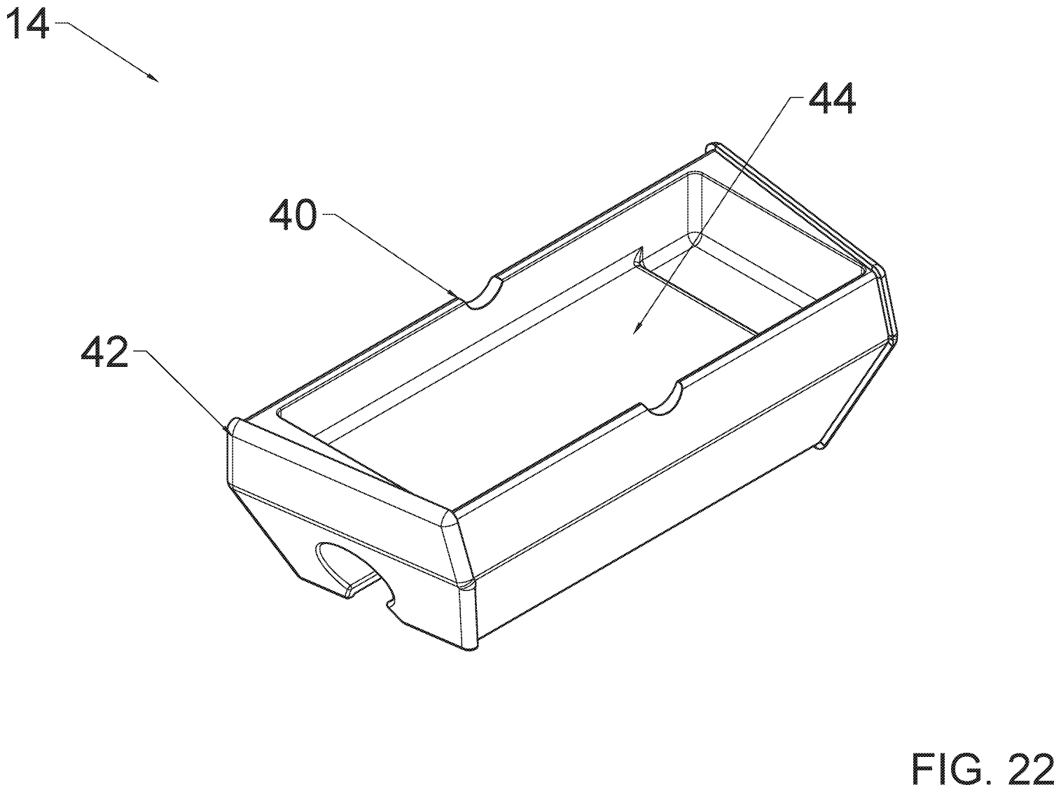

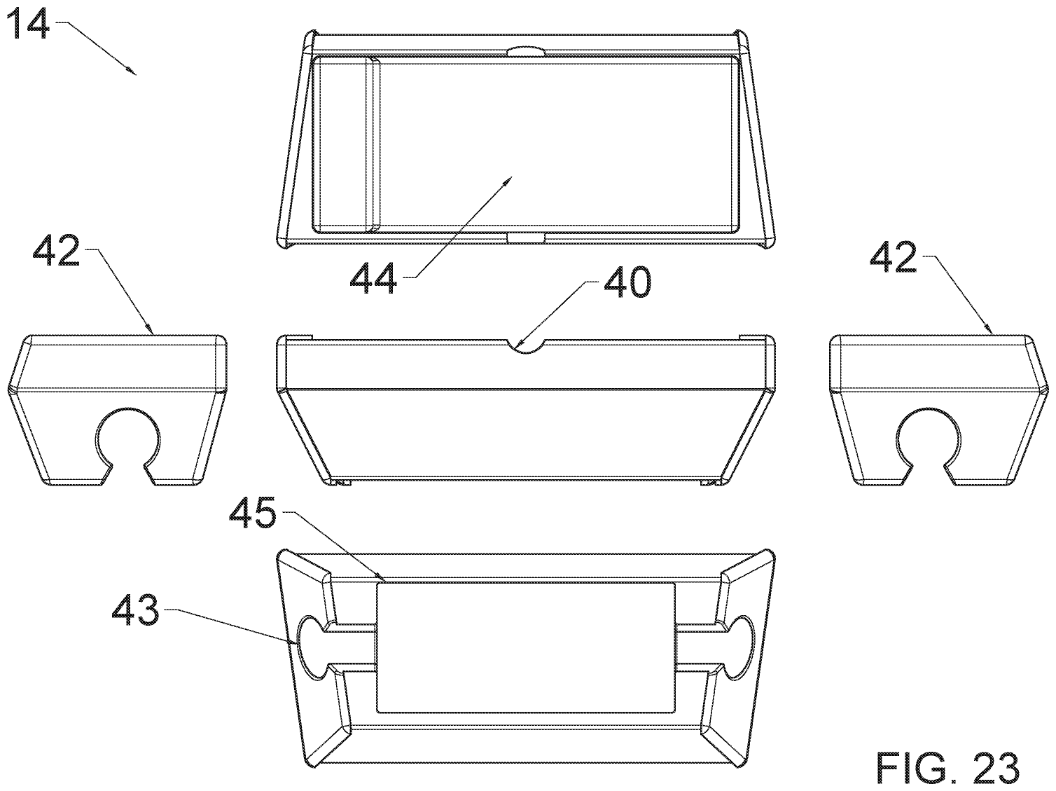

Slots, 41, demonstrated in FIG. 19 and FIG. 20 demonstrate a region to allow for the user to add additional securing and fastening mechanisms such as but not limited to cable ties which further prevents the handle bar pad, 14, from rotating along the lower axis of the handle bar, 11. The handle bar pad contains an opening 43 which allows the handle bar pad flanged edges 42 to press fit to the motorcycle handle bars, 11. FIG. 20 demonstrates a top and bottom view of the handle bar pad, 14. The handle bar pad is further secured to the handle bar mounts, 13, via a press fit/interference fit 45. FIG. 21 demonstrates the left/right and front/back view of the handle bar pad. Furthermore, FIG. 22 and FIG. 23 represent a design variant, but not limited to, of the handle bar pad, 14, that performs the aforementioned functionality.

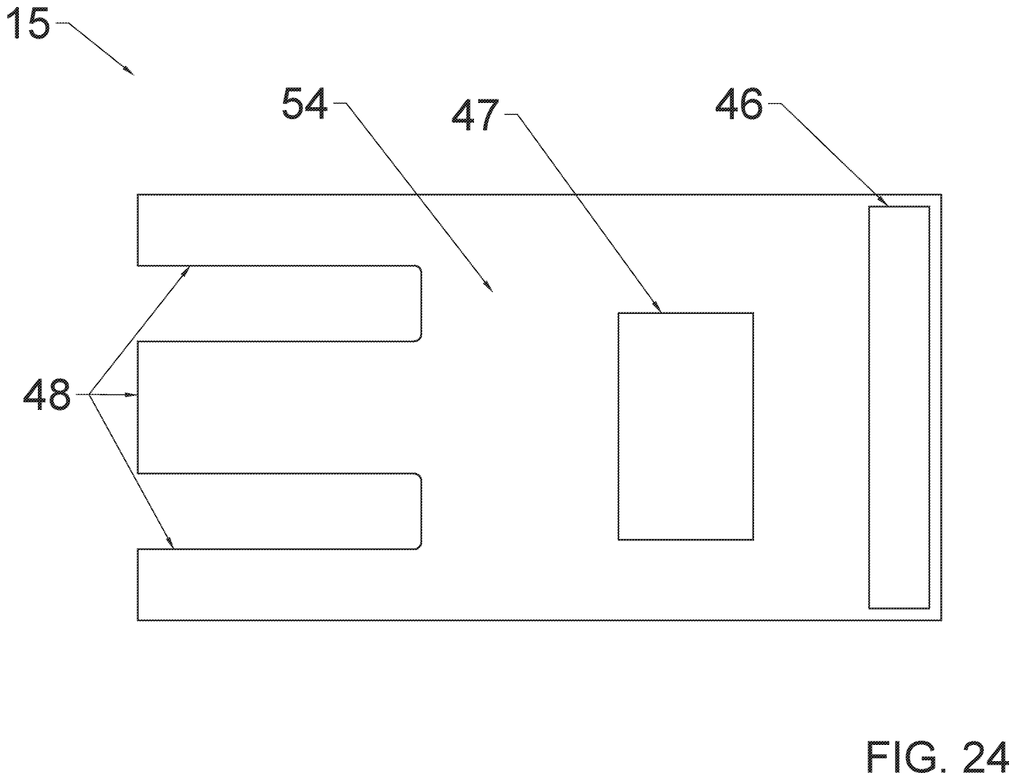

The real-time feedback racing apparatus handle bar pad cover, 15, further secures the handle bar pad and real-time feedback electronic and/or mobile device embodiments to the motorcycle handle bar and handle bar mounts 11 and 13 respectively. The real-time feedback racing apparatus handle bar pad cover is denoted as handle bar pad cover herein. The handle bar pad cover, 15, is composed of one and/or two different polyvinyl chloride (PVC) fabric materials and/or any other suitable materials which provide a rigid and water-resistant enclosure to contain all the various embodiments, 54. Depicted in FIG. 24 is the handle bar pad cover in greater detail in which 15 is decomposed into its various embodiments. The handle bar pad cover designates an area 47 in which the PVC material 54 is to be left clear. This clear area allows for the embedded display screen and/or indicator, 16, to be viewed. All other areas except this designated clear area may have graphic designs printed directly onto the clear PVC material which requires an ultraviolet light curable ink printing processes to adhere ink onto such material substrate. Areas 48 demonstrate cut outs of the handle bar pad cover that allow for the handle bar pad cover to fit between the handle bar and handle bar mounts 11 and 12 respectively.

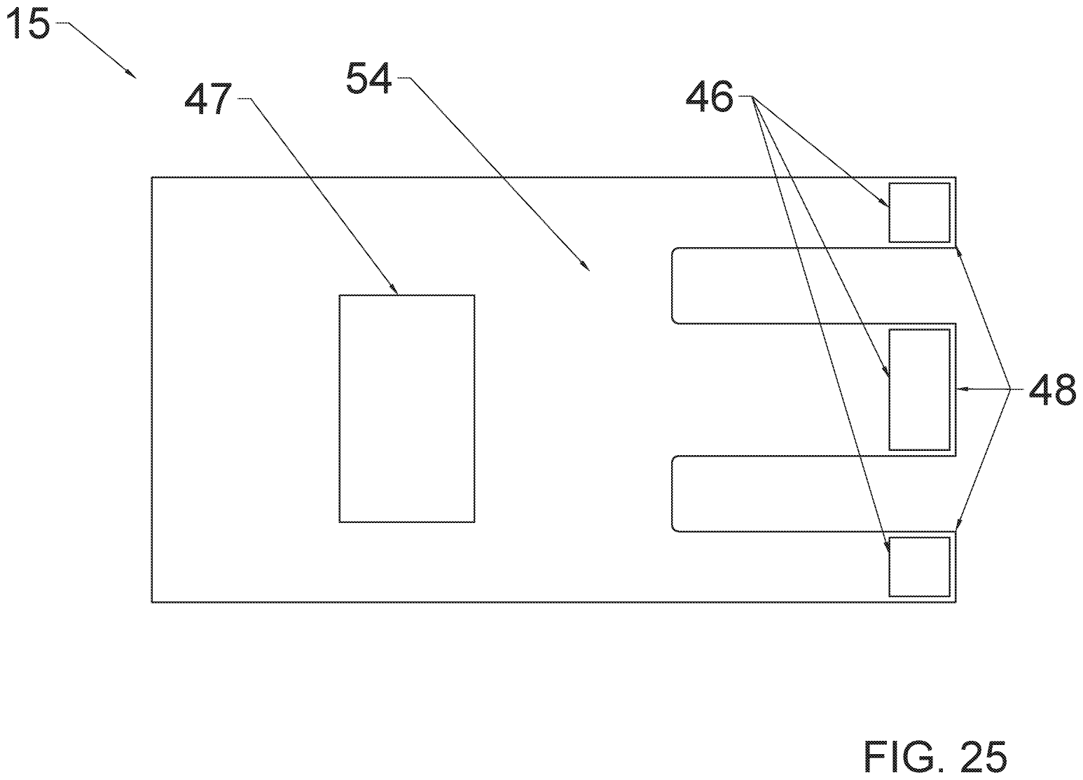

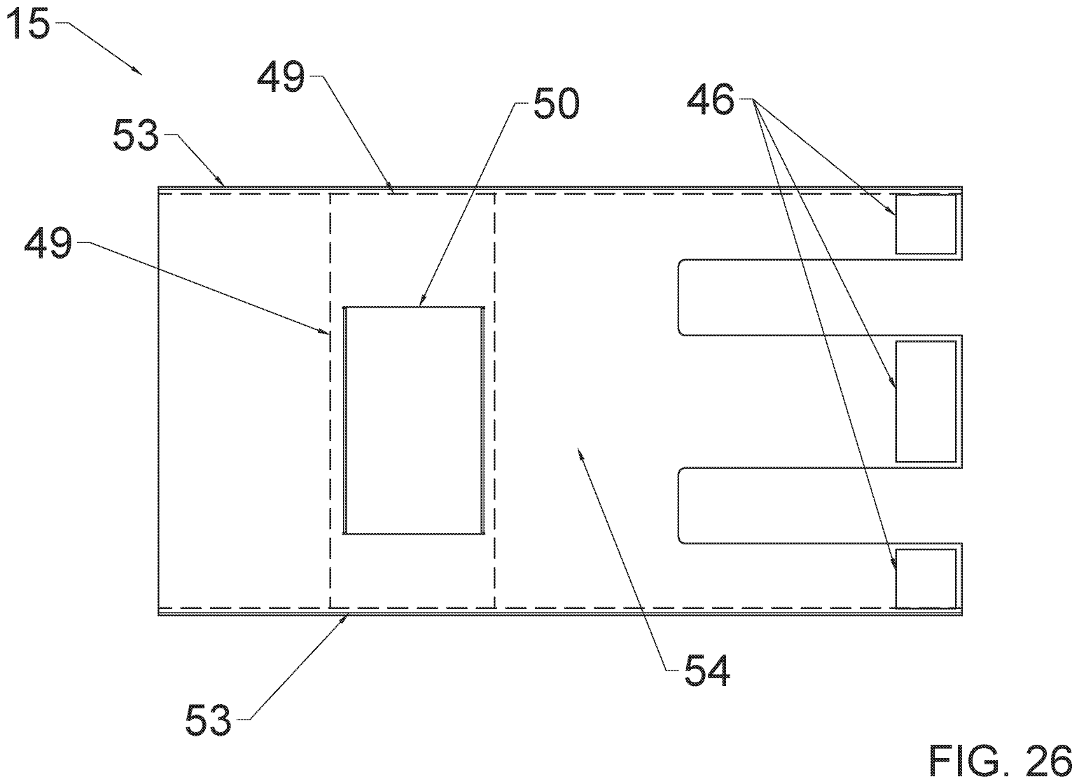

The handle bar pad cover, 15, is to fit around the handle bar pad 14, with its embodied real-time feedback electronic device and/or mobile device, 17, handle bar, 11, and handle bar mounts, 13, and fasten back to itself via a male/female fastening tape mechanism, 46. The male and/or female fastening tape, 46 on the bottom side of the handle bar pad cover is demonstrated on FIG. 25 and FIG. 26. The handle bar pad fastens and secures the entire real-time feedback apparatus to the motorcycle. The fastening tape 46, may be stitched to the handle bar pad cover material, 54, and/or integrated with any other robust and suitable means of mating two materials. The handle bar pad cover secures to itself via the male and female fastening tape, 46, specified in FIG. 24 and FIG. 25 respectively.

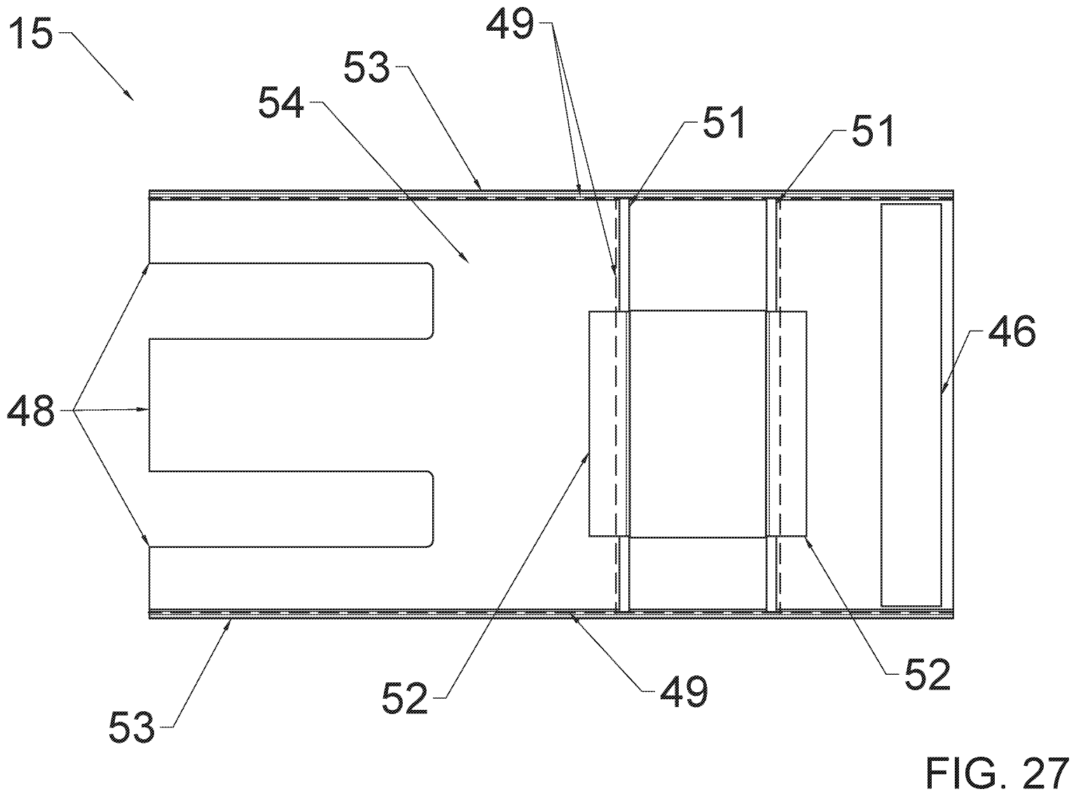

FIG. 26 and FIG. 27 demonstrate a top and bottom variation of the handle bar pad cover, 15, in which the clear area of the PVC cover, 47, is then cut out. This removes the clear material, 47, over the display indicator, 16, that allows for light to reflect off of the clear cover material and reduce the unwanted glare for the user. The PVC material cut out slots are indicated by 52. In order to reduce unwanted folding and bending of the when handle bar pad cover material, 54, is pulled tight, a reinforcement mechanism, 51, is added. This reinforcement mechanism may be any type of plastic can be stitched or secured to the handle bar pad cover material and/or any suitable metal bar or which can then be tightly secured to the cover via the cut out material fold over 52 which is tightly stitched with a fabric against the bar to the handle bar pad cover as indicated by 49.

The complete real-time racing apparatus electronics enclosure with fastened display system fastened onto its surface is to then be press-fit into the handle bar pad mounting device. This mounting device which is again press-fit onto the off-road motorcycle handle bar, but not limited to mounts in the handle bar pad cover that will then further secure the handle bar pad mounting device to the handle bar mounts of the motorcycle but not limited to.

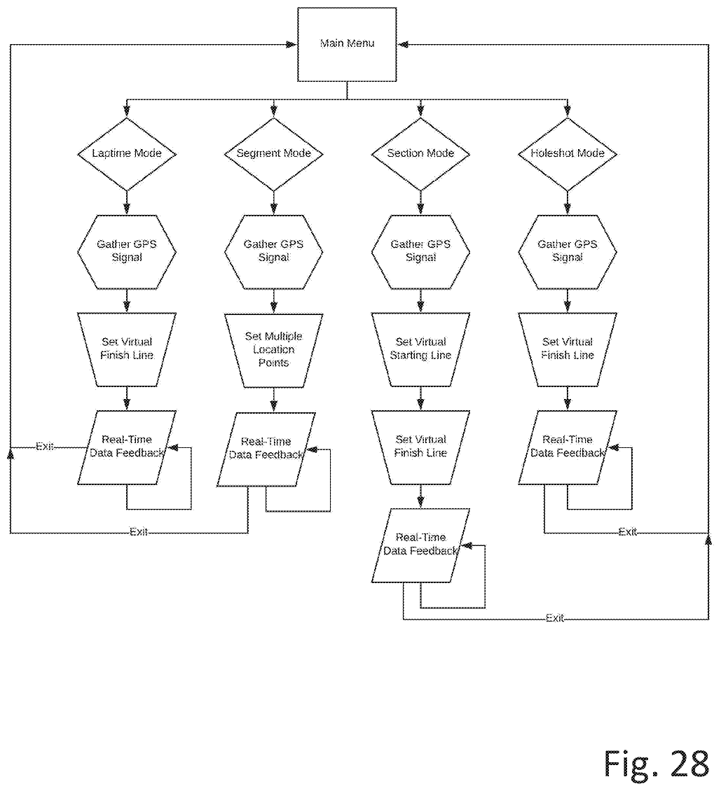

FIG. 28 demonstrates the real-time racing apparatus process operational flow chart. The real-time racing apparatus consists of four different modes in which the user would have a setup process specific to the mode that the user is in but a setup process akin to all other modes. Lap-time mode of the real-time racing apparatus would consist of the user moving on to a specific part of the track to set their finish line by gathering a pair of latitude and longitude coordinates via the real-time racing electronic devices GNSS positioning system. Segment mode would entail the user to going to multiple points on the track to setup a set of latitude and longitude coordinates in order for the split the track into multiple segments. Section mode would require the user to gather two pairs of latitude and longitude coordinate, a start and finish coordinate pair, in which they would the create a specific section of the track to work on. Lastly, start mode (“holeshot mode”) would consist of the user setting an ‘end of starting point’ pair of latitude and longitude coordinates in order to measure time to start point.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

What is claimed is:

1. A real-time racing system comprising a vehicle mount and real-time feedback electronic device, the electronic device comprising a display screen or indicator, GPS and Bluetooth receiver, cellular communication module for real-time data transfer, energy storage system, and microprocessor comprising a memory having stored thereon real-time racing software.

2. The system of claim 1, wherein the vehicle mount is configured for mounting on an off-road motorcycle and comprises a handle bar pad configured to receive the electronic device and a handle bar cover configured to secure the electronic device to the pad.

3. The system of claim 1, wherein electronic feedback device is configured data from external inputs, optionally a heart rate monitor, and wherein the real-time software is configured to determine split-difference lap time, elapsed time and other relevant information.

4. The system of claim 1, wherein the system is configured to establish data link, optionally in real-time, with at least one other device.
